(19) United States
(12) Patent Application Publication
(10) Pub. No.: US 2022/0358575 A1
(43) Pub. Date: Nov. 10, 2022

(54) SYSTEM FOR CHECK IMAGE CAPTURE

(71) Applicant: Vertifi Software, LLC, Burlington, MA (US)

(72) Inventor: Christopher E. Smith, Brookline, NH (US)

(73) Assignee: Vertifi Software, LLC, Burlington, MA (US)

(21) Appl. No.: 17/314,906

(22) Filed: May 7, 2021

(51) Int. Cl. G06Q 40/02; G06T 7/00; G06Q 20/04; G06Q 20/10

(52) U.S. Cl. CPC G06Q 40/02; G06T 7/0008; G06Q 20/0425; G06Q 20/108; G06T 2207/30176

(57) ABSTRACT

Image quality metrics are applied to the entire image within the field of view of a camera associated with a mobile device and are combined with non-image metrics applied to the device to provide a hybrid approach to capturing a quality image that is not dependent upon the check image satisfying a monitoring criterion. When the composite image passes image monitoring criteria and the device passes a non-image criterion, an image may be captured by the camera either manually or automatically. The process may be applied to capture images of both the front and the back of the check, and may be applied to multiple checks. The images may then be submitted for processing for deposit of the check or checks into the user's bank account without the requirement that the user review and approve the image or images of the back of the check or checks.

### STATEMENT REGARDING FEDERALLY SPONSORED RESEARCH OR DEVELOPMENT

Not Applicable.

### CROSS-REFERENCE TO RELATED APPLICATIONS

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Many technologies have been developed to provide businesses and consumers with the ability to capture and transmit document images electronically via desktop and mobile devices. These remote deposit capture (RDC) technologies allow users to transmit instruments such as a check by sending images acquired from a digital camera, scanner, mobile phone, or other device in a matter of seconds. Users can take pictures of documents using the camera in such devices and then transmit the document images for further processing, such as submission for deposit into an account. These technologies can save money for institutions by reducing item processing costs and labor expense, and can provide substantial convenience for businesses and individuals.

Successful RDC processes begin with and depend upon capture of quality images of documents that adequately convey the substance of the information on the face of the documents. Various metrics that represent objectively measurable check image quality defects may be employed to assess the quality of candidate images for capture. With these metrics, deviations from a perfectly complete and accurate image can be assessed by standard technical measurements that do not involve subjective judgments.

Current technologies generally apply image quality metrics to the characteristics of the document image that appears in the foreground of the field of view of a camera. The image quality assessment hierarchy typically proceeds through defect assessment as applied to that foreground image, which may include capture system characteristics and calibration, image defect presence, initial data presence metrics, and various usability assessments.

### SUMMARY

The present invention presents methods and systems that expand image quality analyses beyond the document image in the foreground of the field of view of a camera associated with a mobile device. The invention relies upon image quality metrics applied to the entire image within the field of view of a camera combined with non-image metrics to provide a hybrid approach to capturing a quality image. The objects of this invention include: providing a method of capturing document images with a mobile device that is not dependent upon monitoring the image of the document; providing a method of capturing document images that is based upon the total image within the field of view of a camera satisfying a plurality of criteria; providing a method of capturing document images with a mobile device that does not rely upon feedback instructions to the user or satisfaction of alignment criteria; providing a method of capturing document images with a mobile device that includes at least one non-image quality criterion; and minimizing the need for user approval of multiple check images.

Other objects and advantages of the invention will be apparent from the following summary and detailed description of the invention, taken with the accompanying drawings.

### DESCRIPTION OF THE DRAWINGS

The present invention is described in detail with reference to the following figures. The drawings are provided for purposes of illustration only and merely to depict example embodiments of the invention. These drawings are for illustrative purposes and are not necessarily drawn to scale.

FIG. 1 is a schematic of a mobile device with an embedded camera and video display screen.

FIG. 2 depicts a sample video display screen with viewfinder at the beginning of an image capture process.

FIG. 3 illustrates a composite frontal image within the boundaries of a viewfinder comprising a foreground document image and a background image.

FIG. 4 depicts the boundaries of the composite frontal image that is monitored relative to specified image criteria.

FIG. 5 illustrates a composite back check image within the boundaries of a viewfinder comprising a foreground document image and a background image.

FIG. 6 shows the boundaries of the composite back image that is monitored relative to specified image criteria.

### DETAILED DESCRIPTION

The present invention is a system and method that may be carried out as a software application running on a device such as a mobile phone as part of an RDC system for capturing images of documents and transmitting them electronically to a remotely located financial institution, deposit processing service, or other target location. Mobile phones that use the application typically have a digital camera embedded in the device or otherwise communicatively coupled to the device's processor that may be used to capture images. The document images that are captured constitute the foreground portion of a composite image presented in the field of view of the camera. The invention provides a method and system for capturing such images that do not depend upon monitoring document images relative to one or more criteria and that are not dependent upon the document images satisfying monitoring or alignment criteria. Instead, the invention relies upon device orientation and the quality of the composite image that comprises a total image presented to a user within a camera's field of view. If the instrument is a check, remote deposit may proceed without user approval of an image of the backside of the check. Feedback regarding image quality may be provided to the user, but is not necessary. Similarly, an alignment guide may be provided to aid the user, but also is not necessary.

The present invention uses on-device software to allow image capture only when certain image and non-image criteria are satisfied. The analysis and image capture control are provided without the need for intermediate communication with a server. This results in increased speed of processing and reduced rates of rejection of images received for processing from the remote device.

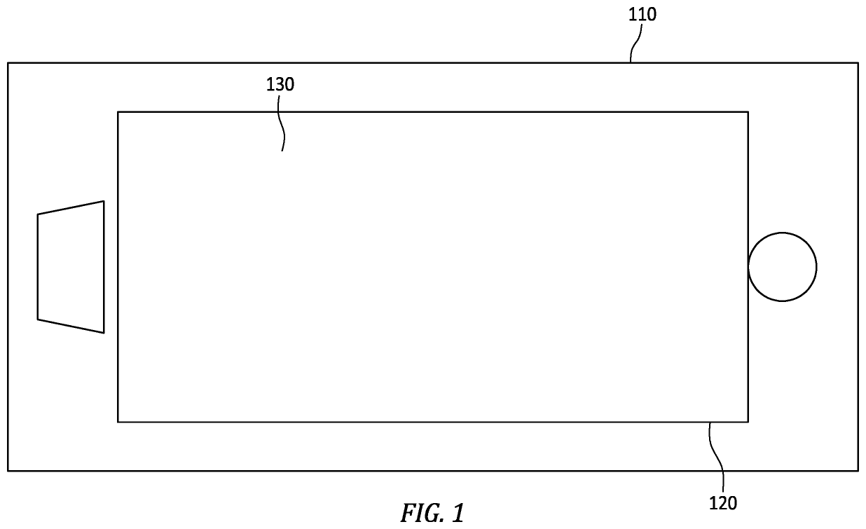

FIG. 1 provides a schematic of a mobile device 110 with an embedded camera. Typically, occupying most of one flat side of the device is a light emitting diode (LED) or liquid crystal display (LCD) screen (“video display screen”) 120. The video display screen, in the phone's camera mode, displays a rapid series of images reproducing the images that are within the field of view of the camera. The video images are a series of composite images 130 of all that is within the camera's field of view at any given moment.

In one embodiment, when a user activates the application on the device to make a financial transaction, the user may be provided initially with a form of welcome screen that may provide an option of making a deposit. Upon selecting such option, the user may then be provided with any of a variety of instructions, which may include, by way of example only, verification of payee, confirmation of consistency of amounts indicated by legal amount and courtesy amount, verification of signature, or instructions regarding the capturing of a check image.

The user may then be provided access to image capture capabilities. This may first include an invitation or instruction to capture an image of one or both sides of the check. Optionally, it may also include a request for entry of certain initial information such as, for example, the selection of a target account for the deposit.

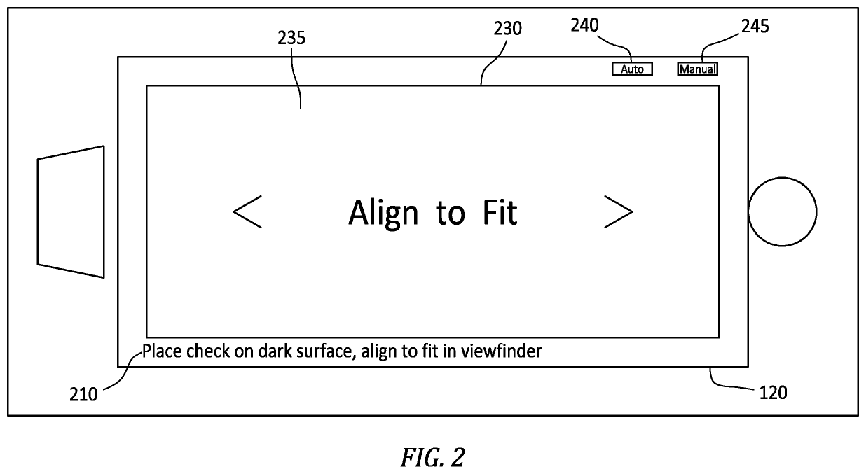

FIG. 2 shows just one example of what may be displayed in the video display screen 120 when beginning the capture of the front image of a check. New margins may be provided within the video display screen, which may be described as defining the viewfinder 230. The entire image within the field of view of the camera can now be displayed as the composite images within the viewfinder 235. The software may provide one or more static instructions 210 within the margins of the video display screen 120 or elsewhere relating to the image capture process, such as, for example, aligning the device relative to the check so that an image of the check appears in the projected viewfinder 230 within the video display screen 120. For example, such instruction 210 may be “Place check on a dark surface,” or “Align to fit within viewfinder.” The presence of the instruction may be static and independent of any further action taken by the user, and may be temporary or remain visible throughout the process. No instruction assisting with the alignment need be provided during the image capture process, and alignment of the document may not be a necessary criterion for image capture to occur.

The user may be given the option of operating in automatic or manual mode. By way of example, such options may be provided by on-screen “buttons” for automatic 240 and manual 245. Should the user select manual 245, the software provides for manual capture and the user may capture the image by, for example, touching a specified area of the screen, but only if the applicable image and non-image criteria are satisfied. If these criteria are not satisfied, the user will not be able to capture an image with the camera. In the automatic mode 240, the device will automatically capture the image 235 appearing in the field of view of the camera as shown in the viewfinder 230 when the composite image and device satisfy the applicable criteria over a specified period of time.

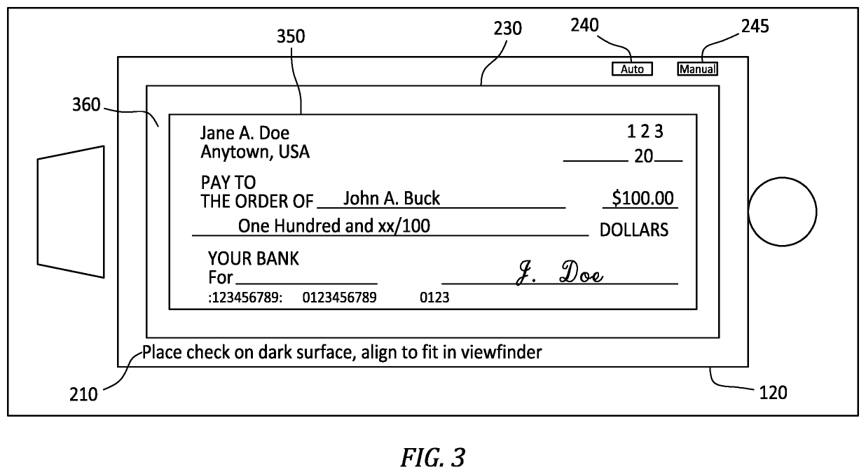

As shown in FIG. 3, the image capture process may proceed with the user placing the document relative to the device such that the image of the document 350 appears to the user within the boundaries of the viewfinder 230 as a component of the composite image 235 of FIG. 2. The image of the document 350 typically constitutes the foreground of the composite image 235, with the remainder of the composite image constituting the background image 360. That is, the total, or composite, image 235 now within the viewfinder 230 of FIG. 2 is made up of the document image 350, which is the foreground image, plus the background image 360.

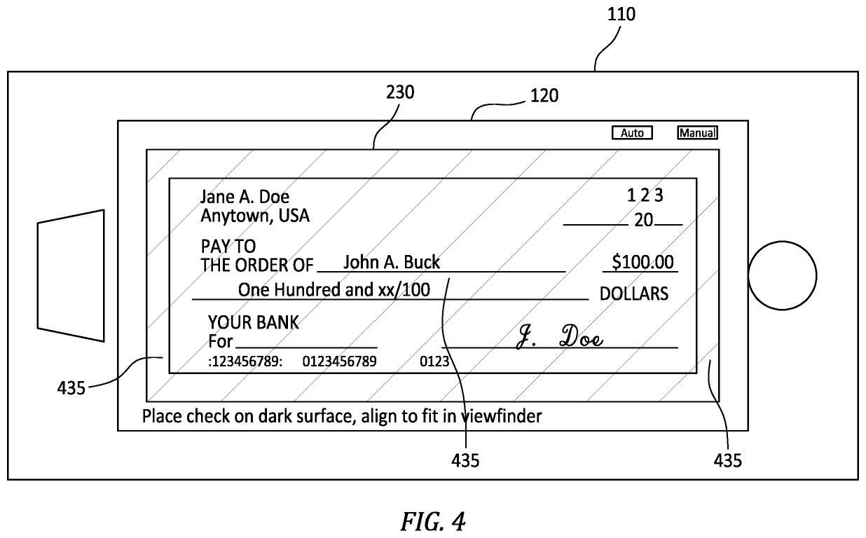

FIG. 4 shows in cross-hatch the composite image 435, consisting of both the foreground image 350 and the background image 360 of FIG. 3, as seen in the viewfinder 230 of the video display screen 120. The software will monitor the entire composite image 435 as well as at least one characteristic of the device itself 110 according to specified criteria. The criteria may involve defect assessment of the image 435 or the device 110. This approach involves determining, based on criteria that can be applied uniformly to all measurement circumstances, whether or to what extent a particular defect is present. A variety of image and non-image defects are possible. Assessment of all possible defects is not necessary, however, to provide an adequate assessment of image usability.

Defect assessment involves both a quantitative measurement of an attribute of the image 435 (e.g., image luminosity) and a qualitative assertion about the presence of a defect (e.g., image too dark) applied to that image. A variety of quantitative image measurements are available and may be used. The corresponding qualitative assertions depend upon the thresholds that are established for each metric or combination of metrics that strike an appropriate balance between correctly identifying defects that may affect usability, and thus avoiding capture of bad images, and incorrectly identifying defects that won't affect the usability of the image. The quality of the performance of the system may be dependent upon setting optimum numerical thresholds based upon data concerning the frequency with which each defect occurs in the real world of image capture.

By way of example, one image quality criterion that may be applied is the average luminosity or “brightness” of the pixels within the image 435. As camera frames are received from the camera of the mobile device 110, the “red-green-blue” (RGB) values of the pixels of each image may be converted to grayscale and the luminosity value of each pixel determined using a specified formula, such as the NTSC formula: 0.299·Red+0.587·Green+0.114·Blue, where Red, Green, and Blue are the respective red, green, and blue values of the pixel. The calculated luminosity values of the pixels may be averaged over the entire image, with the result tested against a pre-determined threshold (for example, 0.2), where a lower value indicates a dark frame. If the mean value is less than the threshold value, then the luminosity criterion for the composite image has not been met.

By way of further example, another image criterion that may be applied is the focus quality of the image 435. Focus may be quantitatively assessed using a variety of measures, such as gradient measure, frequency domain, auto-correlation, or variance measure. Gradient measure is a common measure and involves calculating the sum of the difference between every n^{th} pixel in both the X and Y directions of the image 435. As an image comes into focus, edges become sharper, thus increasing the gradient measure of the image. For example, as image frames are received from the camera of a mobile device, the pixels may be converted to grayscale and measured for a “focus score.” A focus score is a measure as a ratio of maximum video gradient between adjacent pixels, measured over the entire image and normalized with respect to the image's gray level dynamic range and pixel pitch. The following formula may be used to compute a score for image focus:

$$Image Focus Score = \frac{( Maximum Video Gradient )}{( Gray Level Dynamic Range ) * ( Pixel Pitch )}$$

Where,
Video Gradient=ABS [(Gray level for pixel “i”)−(Gray level for pixel “i+1”)]
Gray Level Dynamic Range=[(Average of the “N” Lightest Pixels)−(Average of the “N” Darkest Pixels)]
Pixel Pitch=[1/Image Resolution (in dpi)]
ABS means absolute value
   A blurry composite image will have a low gradient between adjacent pixels as compared to the overall dynamic range of the grayscale pixels and thus a low image focus score. In any event, the resulting score is tested against a pre-determined threshold (e.g., 64) to determine whether an unacceptable focus defect is present. Similar to the luminosity criterion, an image will fail the focus criterion if the calculated image gradient value over the entire image 435 is less than a threshold value.

Other criteria may be applied. For example, and without limitation, the composite image 435 could be assessed as to whether it satisfies range of color values, depth, or distance criteria.

In addition to monitoring and evaluating the image frames from the camera's field of view, the process relies upon monitoring at least one non-image criterion. For example, the software may monitor the orientation of the device 110 to assure that the device is oriented in an acceptable direction before the image 435 shown in the viewfinder 230 is captured. This may be done by employing a gyroscope, which typically is present in mobile devices running Apple iOS or Google Android operating systems. The orientation monitoring process may entail evaluating whether the device is oriented in a sufficiently downward direction, within a pre-determined tolerance. By way of example, such a tolerance may be 0.85, where 1.0 represents gravity, but any tolerance may be used depending upon the orientation required.

A temporal element may be applied to assure stability of criteria satisfaction. For example, in automatic mode, upon satisfaction of the required criteria, picture taking may be initially deferred (e.g., 500 milliseconds) to assure such stability. After such deferral, image capture may be “scheduled,” and a countdown timer, such as 3-2-1, displayed on the device display may be used as a lead up to the action of image capture. If, during the countdown, the composite image 435 or the device 110 fails to satisfy any of the criteria, the countdown may abort without image capture.

Upon satisfaction of the criteria over time, the device may communicate in some manner with the user and image capture may occur either manually or automatically. For example, in automatic mode, after a plurality of composite image criteria are satisfied and one non-image criterion is satisfied over a specified time period, a countdown may appear on the video display screen with a message such as “Hold Steady,” followed by automatic capture of the image. In the manual mode, a signal may be provided to the user when the criteria are satisfied and the user may capture the image at any time thereafter so long as the criteria remain satisfied. In one embodiment of the manual mode, a message may appear after the criteria are satisfied that may direct the user, for example, to “tap when ready,” to alert the user that they may manually initiate picture taking at any time.

Independent of the image and device criteria evaluation, notice may be provided to the user when the foreground image passes one or more document image criteria. For example, alignment notice may be provided to the user when the document image in the foreground of the viewfinder is adequately framed. A technique such as edge or corner detection may be employed for this purpose. The notice may be provided by sound, words, or image, such as an illuminated box. Image capture, however, may occur independent of the notice mechanism or any other document image criterion applied to the foreground image, and may transpire regardless of whether any notice has been provided or other document image criterion applied to the foreground image is satisfied.

After capture, the image of the front of the document may be extracted from the composite image 350. The document image may be shown to the user in the viewfinder 230. The image may be shown in color or as a black and white or grayscale version of the image. If the document image is a check, the user may, by way of example, review the image to ensure that certain check features, such as payee, date, amounts, signature, and MICR line, are clear and legible. If the image is not acceptable to the user, the user may discard it and capture a new image.

The image may be sent automatically to a remote server of for example, a check deposit processing system for processing, or the processing may occur on the device itself. The image 350 may be evaluated relative to a variety of document image criteria, such as height, width, or the presence of edges, corners, or MICR numbers. The processing may also involve electronic reading of the amount of the check, such as through optical character recognition (OCR). If one or more of certain of the document image criteria are not satisfied, the image may be rejected, with a message provided to the user, which may include a suggestion that a new photograph be taken.

Similarly, the amount of the check that is read may be displayed to the user, who may be alerted if that amount and an amount that the user may have entered do not match, and the user may be provided the opportunity to enter a revised amount. If the amount of the check could not be determined, a message may be provided to the user, such as “Deposit Incomplete” or “Amount Required,” indicating that the user must explicitly provide the amount of the check. Typically, processing of the transaction will not be completed if a check amount has not been determined by the software or entered by the user.

The user may also capture an image of the back of the document. This may be preceded by instructions to the user, such as, if the document is a check, to turn over the check to endorse it on the back. Other instructions may be given such as directing that the endorsement be restricted; for example, “for mobile deposit only.” Other static or transient instructions may be given, such as “Sign & Align,” and may include an explicit instruction to capture an image of the back of the document.

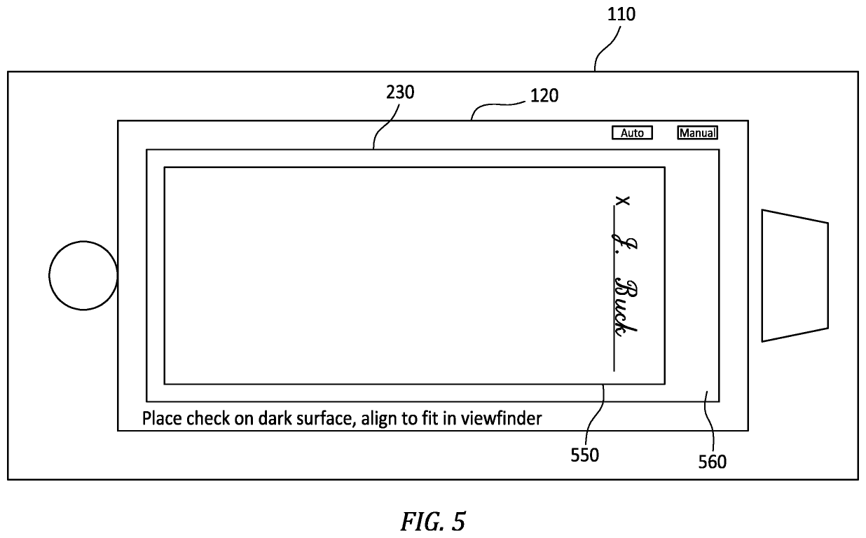

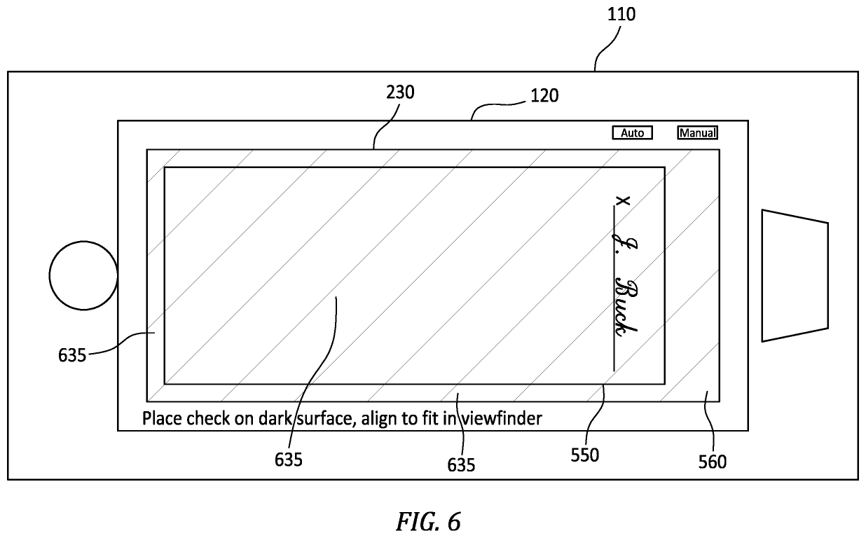

As shown in FIG. 5, the capture of the image of the back of the document proceeds with the user placing the document relative to the device such that the image of the back of the document 550 appears to the user within the boundaries of the viewfinder 230. The image within the viewfinder 230 is now composed of the image of the back of the document 550 in the foreground and the background image 560 comprising the remainder of the image in the field of view. FIG. 6 shows in cross-hatch the composite image 635 containing the image of the back of the document 550 in the foreground and the background image 560.

Capture of the image of the back of the document may proceed as with capture of the front image of the document. The software will monitor the entire, composite image 635 as seen in the viewfinder 230, with the composite image and the device evaluated according to specified criteria. Image and non-image criteria are used. In automatic mode, after a plurality of composite image criteria are satisfied and at least one non-image criterion is satisfied for a specified period or periods of time, an alert may be given to the user, such as “Hold steady,” followed by the device's camera automatically capturing the image, possibly after providing a countdown or similar further alert. If, at any time prior to actual image capture, the composite image or device fails to satisfy any of the criteria, the image capture process may abort without image capture. In manual mode, a message may appear after the image, non-image, and temporal criteria are satisfied that alerts the user that they may now capture an image, and the user may then manually initiate the picture taking at any time while the criteria remain satisfied. The user will be unable to capture an image if any of the required criteria become unmet.

Independent of the criteria evaluation, edge detection may also be separately employed to alert the user when the image of the back of the document 550 in the foreground of the composite image 635 is adequately framed, although image capture need not be dependent upon satisfaction of any such document image criterion.

Once the composite image 635 is captured, the image of the back of the document 550 may be extracted from the composite image and automatically sent to a server such as a server at a check deposit system of a financial institution or deposit processing service, for evaluation, or evaluation may occur on the device. The document image 550 may be evaluated relative to a variety of criteria. For example, the document image may be evaluated for the presence of a signature endorsement. If none appears, or if a restrictive endorsement is required and not detected, a warning may be given to the user or the image may be rejected with instructions to provide the needed endorsement and retake the photo. The image of the back of the document may be evaluated for any of a variety of other criteria, such as edge detection, width or height parameters, and relative width and height to the associated front image, and rejected if one or more criteria are not met, possibly with an instruction to take another photo.

After acceptable images of the front and back of the document are captured, the frontal image is shown to the user. The image of the back of the document may also be shown to the user, but is not necessary. If a check, the detected amount of the check may also be shown.

Prior to submission of the document for processing, the user may be given the option to capture images of one or more additional documents. This may occur, for example, by the tapping of an “Addition” symbol on the device. Capture of those images may proceed as described above.

Upon completion of the image capture process, the user may then provide an instruction for the server to begin processing of the document or documents whose images have been captured. If the document or documents are checks, this may include an instruction to a server related to a check deposit processing system, such as a financial institution or deposit processing service, to submit the images for deposit, such as by tapping a “Submit” symbol or by way of another indication of approval for the deposit to proceed. The device may then provide the user with options, such as including a memo with the deposit. Following submission, the user may receive notice that the processing has been successful, which may include notice that the check or checks have been submitted remotely to a financial institution for deposit. The user may also be provided with information relating to the status, timing, and/or other aspects of the deposit process or other transaction.

1. A non-transitory computer-readable medium comprising computer-readable instructions for depositing a check that, when executed by a processor, cause the processor to:
monitor relative to a plurality of image criteria each composite image presented by each video frame of a series of video frames passing within a field of view of a camera of a mobile device operated by a user, wherein each a composite image comprises a single foreground image and a single background image within a single video frame within the field of view of the camera of a mobile device operated by a user, and wherein the each foreground image consists of an image of the check;
monitor the mobile device relative spatial orientation criterion;
allow capture of the a first composite image presented by a video frame within the field of view of the camera if the first composite image passes the plurality of image criteria and the device passes the spatial orientation criterion;
process the first composite image to extract the check image from the first composite image; and
transmit the extracted check image via a communication pathway between the mobile device and a check deposit processing system serving a depository.

2. The non-transitory computer-readable medium of claim 1, wherein the capture of the first composite image is allowed only when one or more of the image criteria, applied to each composite image of each video frame of the series of video frames, and the spatial orientation criterion applied to the mobile device are all satisfied for a specified period of time.

3. The non-transitory computer-readable medium of claim 1, wherein the capture of the first composite image occurs automatically when the composite image passes the plurality of image criteria and the device passes the spatial orientation criterion.

4. The non-transitory computer-readable medium of claim 3, wherein the capture of the first composite image occurs automatically when one or more of the image criteria and the spatial orientation criterion are satisfied for a specified period of time.

5. The non-transitory computer-readable medium of claim 1, wherein the processor is configured further to provide notice to the user, prior to capture of the first composite image, when the foreground image within the first composite image passes an alignment criterion.

6. The non-transitory computer-readable medium of claim 1, wherein an instruction or notice is provided to the user when one or more of the image criteria or the spatial orientation criterion are satisfied prior to capture of the composite image.

7. The non-transitory computer-readable medium of claim 1, wherein the extracted image is evaluated relative to one or more document image criteria after extraction from the first composite image.

8. The non-transitory computer-readable medium of claim 7, wherein notice is provided to the user if the extracted image fails to satisfy one or more of the document image criteria.

9. The non-transitory computer-readable medium of claim 1, wherein the instructions further cause the processor to send an instruction to the check deposit processing system to submit the extracted check image for processing into a financial account for the user.

10. The non-transitory computer-readable medium of claim 9, wherein the extracted check image is not shown to the user before an instruction is sent to the check deposit processing system to submit the extracted foreground image of the check for processing into a financial account for the user.

11. The non-transitory computer-readable medium of claim 1, wherein the user does not enter an amount of the check before the extracted check image is transmitted to the check deposit processing system.

12. A system for depositing a check, comprising a mobile device having a camera and a processor, wherein the processor is configured to control the camera and to:
monitor relative to a plurality of image criteria each composite image presented by each video frame of a series of video frames passing within a field of view of the camera relative to a plurality of image criteria, wherein
each composite image comprises a single foreground image and a single background image within a single video frame, and
each foreground image includes an image of the check;
monitor the mobile device relative to a spatial orientation criterion;
capture a first composite image presented by a video frame within the field of view of the camera if the first composite image passes the plurality of image criteria and the device passes the spatial orientation criterion;
process the first composite image to extract the check image from the first composite image; and
transmit the extracted check image via a communication pathway between the mobile device and a check deposit processing system serving a depository.

13. A method for remotely submitting a check for processing into a financial account for a user, comprising:
monitoring relative to a plurality of image criteria each composite image presented by each video frame of a series of video frames passing within a field of view of a camera of a mobile device operated by a user, wherein each composite image comprises a single foreground image and a single background image within a single video frame within the field of view of the camera of the mobile device operated by the user, wherein each foreground image consists of an image of the check;
monitoring the mobile device relative to a spatial orientation criterion;
capturing the first composite image presented by a video frame within the field of view of the camera if the first composite image passes the plurality of image criteria and the device passes the spatial orientation criterion;
processing the first composite image to extract the check image; and
transmitting the extracted check image via a communication pathway between the mobile device and a check deposit processing system serving a depository.

14. The method of claim 13, further comprising:
evaluating the extracted check image for the presence of an endorsement that satisfies a criterion; and
if an endorsement that satisfies the criterion is not detected, rejecting the extracted check image; and
providing a notice or instructions to the user to capture another image of the check;
if an endorsement that satisfies the criterion is detected, sending an instruction to the check deposit processing system to submit the extracted check check image for processing without first showing the extracted foreground image to the user.

15. The method of claim 13, further comprising:
evaluating the extracted check image for a check amount; and
instructing the user to enter an amount of the check if the amount cannot be read from the extracted check image.

16. A non-transitory computer-readable medium comprising computer-readable instructions for depositing a check that, when executed by a processor, cause the processor to:
monitor relative to a first plurality of image criteria each composite image presented by each video frame of a first series of video frames passing within a field of view of a camera of a mobile device operated by a user, wherein each a first composite image comprises a first single foreground image and a first single background image within a single video frame within the field of view of the camera of the mobile device operated by a user, wherein the first each foreground image consists of an image of the front of the check;
monitor the mobile device relative to a first spatial orientation criterion;
capture a first composite image presented by a first video frame within the field of view of the camera if the first composite image passes the first plurality of image criteria and the device passes the spatial orientation criterion;
process the first composite image to extract the first check image from the first composite image;
present the extracted first check image to the user after the image is captured;
transmit the extracted first check image via a communication pathway between the mobile device and a check deposit processing system serving a depository;
monitor relative to a second plurality of image criteria each composite image presented by each video frame of a second series of video frames passing within a field of view of a camera of the mobile device operated by the user, wherein each a-second composite image comprising comprises a second single foreground image and a second single background image within a single video frame within the field of view of the camera of the mobile device operated by a user, and wherein the second each foreground image consists of an image of the back of the check and the second plurality of image criteria may be the same as or different from the first plurality of image criteria;
monitor the mobile device relative to a second spatial orientation criterion, wherein the second spatial orientation criterion may be the same as or different from the first spatial orientation criterion;
capture a second composite image presented by a second video frame within the field of view of the camera if the second composite image passes the second plurality of image criteria and the device passes the second spatial orientation criterion;
process the second composite image to extract the image of the back of the check from the second composite image;
evaluate the extracted image of the back of the check for the presence of an endorsement that satisfies at least one endorsement criterion; and
if an endorsement that satisfies the at least one endorsement criterion is not detected,
reject the extracted image of the back of the check and
provide a notice or instructions to the user to capture another image of the back of the check;
if an endorsement that satisfies the at least one endorsement criterion is detected,
transmit the extracted image of the back of the check from the mobile device to the check deposit processing system without first showing the image of the back of the check to the user;
receive an instruction from the user to submit the check images for processing for deposit into a financial account for the user; and
send an instruction to the check deposit processing system to submit the check for deposit into a financial account for the user.

17. The non-transitory computer-readable medium of claim 16,
wherein the check deposit processing system:
evaluates the extracted check image for a check amount; and
instructs the user to enter an amount of the check if the amount cannot be read from the extracted check image.

18. The non-transitory computer-readable medium of claim 16,
wherein the computer-readable instructions cause the processor further to:
evaluate the extracted check image for a check amount; and
instruct the user to enter an amount of the check if the amount cannot be read from the extracted check image.
